(19) United States
(12) Patent Application Publication
(10) Pub. No.: US 2009/0163663 A1
(43) Pub. Date: Jun. 25, 2009

(54) METHOD OF PREPARING THERMOPLASTIC POLYURETHANE BLENDS

(75) Inventor: Naseer Mohammad Qureshi, Oshawa (CA)

Correspondence Address: BERESKIN AND PARR, 40 KING STREET WEST, BOX 401, TORONTO, ON, M5H 3Y2, CA

(73) Assignee: ESCALATOR HANDRAIL COMPANY INC., Oshawa (CA)

(21) Appl. No.: 11/972,864

(22) Filed: Jan. 11, 2008

Related U.S. Application Data
(60) Provisional application No. 61/014,831, filed on Dec. 19, 2007.

(51) Int. Cl. C08L 75/04

(52) U.S. Cl. 525/130

(57) ABSTRACT

A method of preparing TPU blend is disclosed. In particular, a method of preparing an TPU blend comprising extruding a mixture of a thermoplastic polyurethane, a polyolefin copolymer blend and an amine-modified polypropylene compatibilizer is disclosed. The resulting TPU blend provides an elastomeric material with significantly less TPU but which retains the elastomeric and mechanical properties of a TPU.

### CROSS-REFERENCE TO RELATED APPLICATION

This application claims the benefit of U.S. Provisional Application No. 61/014,831 filed Dec. 19, 2007, which is incorporated herein by reference in its entirety.

### FIELD

This application relates to a method of preparing an elastomeric thermoplastic polyurethane (TPU) blend, in particular, by extruding a mixture of a thermoplastic polyurethane, a polyolefin copolymer blend and an amine-modified polypropylene compatibilizer. The application further includes uses of this material, in particular, in escalator handrails.

### BACKGROUND

Elastomeric materials are used in the escalator handrail industry. It has been estimated that over 80% of the cost of making an escalator handrail is attributed to the cost of the raw materials used in the construction of the handrail. The largest component when constructing handrails, in terms of both construction and cost, are thermoplastic polyurethane resins. Currently, the cost of thermoplastic polyurethane resins account for 80% of the raw material cost of making escalator handrails.

### SUMMARY

In accordance with the present disclosure, a method of preparing an elastomeric TPU blend is disclosed. In particular, the application discloses a method of preparing a TPU blend comprising reactively extruding a mixture of a TPU, a polyolefin copolymer blend and an amine-modified polypropylene compatibilizer, wherein the polyolefin copolymer blend is a blend of a polyolefin and an elastomeric olefin. The method of the present disclosure results in an elastomeric TPU blend material which significantly reduces the amount of TPU used in its construction, but retains the elastomeric and mechanical properties, such as tensile strength and modulus, of a TPU material.

The present disclosure therefore includes a method of preparing an TPU blend comprising reactively extruding a mixture comprising:
(a) a thermoplastic polyurethane;
(b) a polyolefin copolymer blend, wherein the polyolefin copolymer blend is a blend of:
   (1) a polyolefin, and
   (2) an elastomeric olefin; and
(c) an amine-modified polypropylene compatibilizer.

In particular, the present disclosure relates to a method of preparing a TPU blend comprising reactively extruding a mixture comprising:
(a) a thermoplastic polyurethane comprising from about 40% to about 70% by weight of the TPU blend;
(b) a polyolefin copolymer blend comprising from about 20% to about 50% by weight of the TPU blend, wherein the polyolefin copolymer blend is a blend of:
   (1) a polyolefin comprising from about 30% to about 70% by weight of the polyolefin copolymer blend, and
   (2) an elastomeric olefin comprising from about 30% to about 70% by weight of the polyolefin copolymer blend; and
(c) an amine-modified polypropylene compatibilizer comprising from about 1% to about 15% by weight of the TPU blend.

In an embodiment of the disclosure, the TPU is selected from a polyester-based TPU or a polyether-based TPU. In another embodiment, the TPU is a polyester-based TPU.

In an embodiment of the disclosure, the polyolefin is selected from polyethylene or polypropylene. In another embodiment of the disclosure, the polyolefin is polypropylene.

In an embodiment of the disclosure, the elastomeric olefin is a polypropylene elastomeric olefin. In a subsequent embodiment of the disclosure, the polypropylene elastomeric olefin is able to co-crystallize with polypropylene.

In an embodiment of the present disclosure, the amine-modified compatibilizer is prepared by accurately metering molten diamine into an extruder during reactive extrusion of the maleated polypropylene. In an embodiment of this disclosure, the diamine is an alkylene diamine. In another embodiment, the diamine is a C₄₋₁₂alkylene diamine. In a subsequent embodiment, the diamine is selected from hexamethylenediamine or dodecamethylenediamine.

The present disclosure also includes a TPU blend composition comprising a blend or reaction product of a TPU, a polyolefin copolymer blend and an amine-modified polypropylene compatibilizer, wherein the polyolfin colpoymer blend is a blend or reaction product of a polyolefin and an elastomeric olefin.

The disclosure also includes uses of the elastomeric material composition described herein, for example, for the production of parts for escalator handrails and rollers for use on escalators and elevators; as well as for motor vehicles such as bumpers, spoilers, fenders, as well as tools, appliances, sporting goods, footwear and tube connectors.

Other features and advantages of the present invention will become apparent from the following detailed description. It should be understood, however, that the detailed description and the specific examples while indicating preferred embodiments of the invention are given by way of illustration only, since various changes and modifications within the spirit and scope of the invention will become apparent to those skilled in the art from this detailed description

### BRIEF DESCRIPTION OF THE DRAWINGS

The invention will now be described in relation to the drawings in which:

FIG. 1 is a schematic showing a continuous process for the preparation of the elastomeric material composition in one embodiment of the present disclosure.

FIG. 2 shows IR spectra of various maleated polypropylenes that have been aminated in accordance with an embodiment of this disclosure;

FIG. 3 is a graph showing the loss tangent as a function of temperature for elastomeric material produced in accordance with an embodiment of the present disclosure along with two TPU samples;

FIG. 4 is a graph showing the modulus as a function of temperature for elastomeric material produced in accordance with an embodiment of the present disclosure along with two TPU samples;

FIG. 5 shows back scattering images at various magnifications of a pellet sample of an elastomeric material produced in accordance with an embodiment of the present disclosure;

FIG. 6 shows scanning electron micrograph images at various magnifications of a pellet sample of an elastomeric material produced in accordance with an embodiment of the present disclosure;

FIG. 7 shows back scattering images at various magnifications of an injected molded sample of an elastomeric material produced in accordance with an embodiment of the present disclosure;

FIG. 8 shows scanning electron micrograph images at various magnifications of an injected molded sample of an elastomeric material produced in accordance with an embodiment of the present disclosure;

FIG. 9 shows a viscosity comparison graph of elastomeric material prepared in accordance with an embodiment of the present disclosure along with the various starting materials; and

FIG. 10 is a Cole-Cole plot of elastomeric material prepared in accordance with an embodiment of the present disclosure along with the various starting materials.

### DETAILED DESCRIPTION

This application relates generally to a method of preparing a TPU blend comprising reactively extruding a mixture of a TPU, a polyolefin copolymer blend and an amine-modified polypropylene compatibilizer, wherein the polyolefin copolymer blend is a blend of a polyolefin and an elastomeric olefin.

In embodiments of the disclosure, the method of preparing the TPU blend comprises reactively extruding a mixture comprising:
(a) a TPU comprising from about 40% to about 70% by weight of the TPU blend;
(b) a polyolefin copolymer blend comprising from about 20% to about 50% by weight of the TPU blend, wherein the polyolefin copolymer blend comprises a blend of
   (1) a polyolefin comprising from about 30% to about 70% by weight of the polyolefin copolymer blend, and
   (2) an elastomeric olefin comprising from about 30% to about 70% by weight of the polyolefin copolymer blend; and
(c) an amine-modified polypropylene compatibilizer comprising from about 1% to about 15% by weight of the TPU blend.

In an embodiment of the disclosure, the components of the TPU blend are first dry-blended.

In an embodiment of the disclosure, the TPU comprises from about 40% to about 70% by weight of the TPU blend. In another embodiment, the TPU comprises from about 50% to about 60% by weight of the TPU blend. In a subsequent embodiment, the TPU comprises about 55% by weight of the TPU blend. In an embodiment of the disclosure, the TPU is selected from a polyester-based TPU or a polyether-based TPU. In another embodiment, the thermoplastic TPU is a polyester-based TPU.

The polyolefin copolymer blend component of the mixture comprises from about 20% to about 50% by weight of the TPU blend. In an embodiment, the polyolefin copolymer blend comprises from about 30% to about 40% by weight of the TPU blend. In another embodiment, the polyolefin copolymer blend comprises about 35% by weight of the TPU blend.

The polyolefin copolymer blend is comprised of a polyolefin and an elastomeric olefin. In an embodiment of the disclosure, the polyolefin comprises from about 30% to about 70% by weight of the polyolefin copolymer blend. In another embodiment, the polyolefin comprises about 50% by weight of the polyolefin copolymer blend. In an embodiment, the polyolefin is selected from polyethylene or polypropylene. In another embodiment, the polyolefin is polypropylene.

In an embodiment of the disclosure, the elastomeric olefin comprises from about 30% to about 70% by weight of the polyolefin copolymer blend. In another embodiment, the elastomeric olefin comprises about 50% by weight of the polyolefin copolymer blend. In an embodiment, the elastomeric olefin can be any elastomeric olefin which is able to co-crystallize with the polyolefin. The ability of the polyolefin and the elastomeric olefin to co-crystallize results in polyolefin copolymer blends having desirable service temperatures. In an embodiment, the elastomeric olefin is a propylene elastomer containing isotactic propylene crystallinity. In an embodiment of the disclosure, the elastomeric olefin is a propylene-rich elastomer.

In another embodiment the components of the TPU blend are reactively extruded using a twin screw extruder using methods known in the art. The components of the TPU blend may be melt blended in the extruder and extruded into fine strands, for example, through a two-hole die. The strands of the TPU blend of the present disclosure are then cut into pellets, which can then be shaped and molded for practical use.

The amine-modified polypropylene compatibilizer of the present disclosure comprises from about 1% to about 15% by weight of the TPU blend. In an embodiment, the amine-modified polypropylene compatibilizer comprises from about 5% to about 10% by weight of the TPU blend.

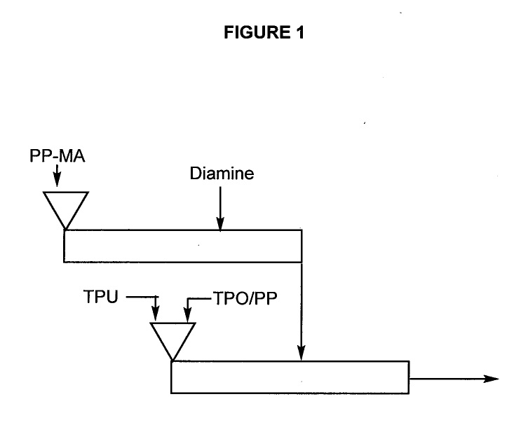

In the method of the present disclosure, the amine-modified polypropylene compatibilizer is prepared by accurately metering molten diamine into an extruder during reactive extrusion of the maleated polypropylene as shown in FIG. 1. This melt-phase amination of the maleated polypropylene during the reactive extrusion process allows accurate metering of the diamine to provide a consistent and reproducible method of preparing the amine-modified polypropylene compatibilizer. In an embodiment, the reactive extrusion process is carried out using a twin-screw extruder. The main factors affecting the amination of the maleated polypropylene are the polymer flow rate and the amine:maleated-polypropylene molar ratio. For example, using a 34 mm Leistritz co-rotating twin-screw extruder, the amine-modified polypropylene compatibilizer is produced using a polypropylene flow rate of about 50 to about 100 grams/minute. In another embodiment, the amine-modified polypropylene compatibilizer is produced using a polypropylene flow rate of about 50 to 75 grams/minute in this twin-screw extruder. A person skilled in the art would appreciate that the flow rate will depend on the size of the extruder and would be able to convert the flow rates reported herein to flow rates for an extruder of a different size. In an embodiment, the amine-modified polypropylene compatibilizer is reactively extruded using a molar ratio of diamine:maleated polypropylene of about 0.5:1 to about 5:1, suitably about 1.5:1. In another embodiment, the amine-modified polypropylene compatibilizer is reactively extruded using a molar ratio of diamine:maleated-polypropylene of about 1:1 to about 3:1. The molar ratio of diamine:maleated polypropylene refers to the ratio amine groups:maleic anhydride groups.

Included within the scope of this disclosure is the operation of two twin-screw extruders wherein the amine-modified polypropylene compatibilizer is produced in one extruder and fed directly into another extruder, which reactively combines the TPU and the polyolefin copolymer blend for production of the elastomeric material. A schematic of this continuous process arrangement is shown in FIG. 1.

In an embodiment of the disclosure, the amine can be any suitable alkylene diamine, and in a subsequent embodiment, the diamine is a C₄₋₁₂alkylene diamine, wherein alkylene includes both straight-chain and branched alkylene groups. In another embodiment, the diamine is selected from hexamethylenediamine or dodecamethylenediamine. In an embodiment, the diamine is hexamethylenediamine.

The method of the present disclosure, results in an elastomeric material which possesses desirable mechanical properties such as tensile strength and elongation at break. It possesses good elastomeric properties as determined by various analytical methods such as using a Dynamic Mechanical Analyzer (DMA) and a rheometer. The blend of the present disclosure also showed desirable elastomeric properties in an accelerated handrail durability test where a handrail made by replacing at least 50% of the TPU with a blend of the present disclosure was tested on a test rig with an escalator drive system. This handrail was able to run at 7 times the normal escalator speed for an acceptable length of time.

The present disclosure also includes an elastomeric material composition comprising a blend or reaction product of a thermoplastic polyurethane, a polyolefin copolymer blend and an amine-modified polypropylene compatibilizer, wherein the polyolfin colpoymer blend is a blend or reaction product of a polyolefin and an elastomeric olefin. In an embodiment of the disclosure, the composition comprises of a blend or reaction product of:
(a) a thermoplastic polyurethane comprising from about 40% to about 70% by weight of the composition;
(b) a polyolefin copolymer blend comprising from about 20% to about 50% by weight of the composition, wherein the polyolefin copolymer blend is a blend of:
   (1) a polyolefin comprising from about 30% to about 70% by weight of the polyolefin copolymer blend, and
   (2) an elastomeric olefin comprising from about 30% to about 70% by weight of the polyolefin copolymer blend; and
(c) an amine-modified polypropylene compatibilizer comprising from about 1% to about 15% by weight of the composition.

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Finally, terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies. The terms “a” and “an” are understood to mean herein “one” or “one or more”.

The following non-limiting examples are illustrative of the present invention:

### EXAMPLES

### Example 1

### Amination Experiments

### (a) Materials and Procedures

The commercial maleated polypropylenes used in this work were provided by Chemtura Corporation (Middlebury Conn.) and were POLYBOND® 3150 and 3200. These contain 0.5 and 1 wt % maleic anhydride (MAH), respectively. Two aliphatic diamines from Sigma-Aldrich Ltd. (Oakville, Ontario) were selected for the amination reaction. These were hexamethyleneldiamine (HMDA) and dodecamethylenediamine (DMDA). Amination experiments were carried out in a 34 mm Leistritz co-rotating twin-screw extruder (TSE). The maleated polypropylene and amine materials were metered separately. The amines were pre-melted using a hot bath and metered at a constant volumetric flow rate through an ISCO 250D syringe pump. The bath temperatures for HMDA and DMDA were set to 60 and 95° C. respectively. All the tubes in and out of the syringe pump were wrapped and heated by electrical heater bands. The controller for the band heater was set to 2 and 5.5, for HMDA and DMDA respectively. The syringe pump was calibrated using a volumetric flask (the pump was running at a set value of 10 ml/min for 30 s, the measured volume of diamine 5.2 ml). The HMDA density at 60° C. is 0.8 g/ml. The DMDA density was estimated experimentally to be 8.1 g/ml.

The factors that were studied included polymer flow rate, screw speed and amine:maleated polypropylene molar ratio. Experiments were conducted according to a statistical design. The diamine:maleated polypropylene molar ratio was varied from 0.5:1 to 3:1.

### (b) Observations

Polybond® 3200 extrudates could not be stretched steadily into a continuous filament for pelletization. After addition of diamines, the melt strength became larger, and strands could be readily stretched into a uniform filament for pelletization. However, at high diamine:maleated polypropylene molar ratio, the extrudates at a low screw speed (50 rpm) were foamy, and bubbly, so stretching of the strands became unsteady. This difference was especially obvious for the DMDA. At a diamine:maleated polypropylene molar ratio of 3, the reactive extrudates for both diamines were foamy and the stretching flow was unsteady. In the case of Polybond® 3150, the strands could be stretched steadily without the addition of the diamines and the previous effects were less pronounced. For both Polybond® materials, the extrudates appeared to be very hard when the diamine:maleated polypropylene ratio was set to 0.5, and the strand stretching was not uniform, leading to frequent breaking of the strands.

### (c) Characterization

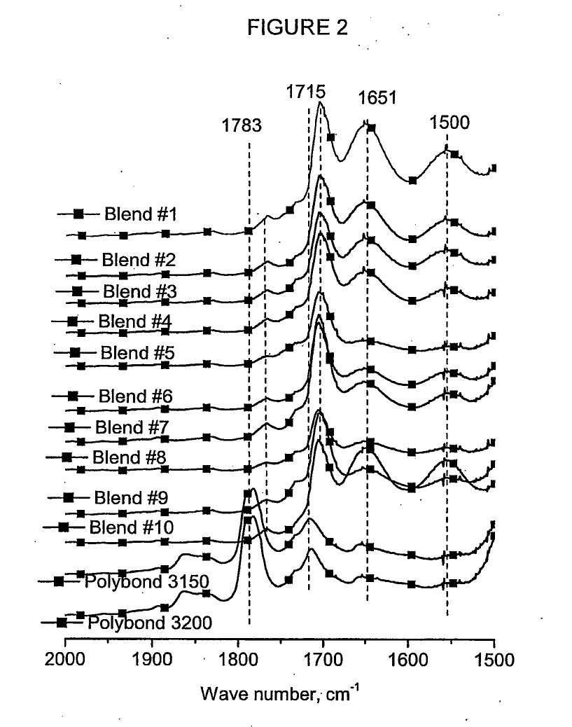

The conversion of maleated polypropylene to aminated polypropylene was characterized by titration and FTIR. Titration and FTIR data clearly follow the maleated polypropylene conversion through reaction with amine groups. Characterization results from FTIR measurements are shown in FIG. 2 and they clearly indicate the conversion of the anhydride groups. One can easily see the decrease in the peak intensity at 1783 cm⁻¹ in the Polybond® samples as the reaction occurs. The corresponding peak positions in the aminated samples are shifted 50 cm⁻¹ due to the reaction. A new peak shows up at 1550 cm⁻¹, while the peak at 1651 cm⁻¹ in the samples is much stronger than in the two Polybond® materials. For quantitative analysis, the internal reference peak at 2723 cm⁻¹ was used. As a double reference check, another peak at 1167 cm⁻¹ was selected. In general, HMDA led to higher amination of the maleated polypropylene for both POLYBOND® materials. Statistical analysis of the results indicates that the most important factors were the polypropylene flow rate and the diamine:maleated polypropylene molar ratio. Based on these results, aminated POLYBOND® samples prepared using a flow rate of 50 g/min or 75 g/min, a screw speed of 50 g/min or 75 g/min and a molar ratio of diamine:maleated polypropylene of 1.5 or 2 (Comp. 1, Comp. 2 and Comp. 3) were selected to be used as amine-modified compatibilizers for the production of the elastomeric materials. For a complete listing of amination conditions for these three compatibilizers, see Table 1.

### Example 2

### Preparation of Elastomeric Materials

The reactive blending of various combinations of two different thermoplastic polyurethanes, TPU1: Pearlthane® 12K85A and TPU2: Pearithane® D12F75 (both from Merquinsa of Barcelona, Spain), three different elastomeric polypropylene blends PP1: 50% Profax® 8523+50% Adflex® V109F, PP2: 50% Profax® 8523+50% Vistamaxx® 3000, and PP3: 50% Profax® 8523+50% Softell® TKS203D (Profax®, Adflex® and Softell® were obtained from Basell Polyolefins, Wilmington, Del. and Vistamaxx® 3000 was obtained from Exxon Mobil Chemical Corp. Houston, Tex.) and three different amine-containing compatibilizers (Comp. 1, Comp. 2 and Comp. 3 from Table 3) was carried out using the same twin-screw extruder and screw configuration that was used for the amination reactions. Both thermoplastic polyurethanes were dried prior to blending using a desiccant dryer supplied by Escalator Handrail Company. After drying, the moisture content was checked and found to be very low (between 0.005 and 0.02%). The dried thermoplastic polyurethane was dry-blended with the polypropylene phase (blend of polypropylene and elastomeric olefin) and the amine-containing compatibilizer and the mixture was fed to the extruder through a loss-in-weight K-Tron feeder. The compositions of the final blends are listed in Table 2 along with their mechanical properties. Mechanical properties were measured using specimens cut from molded plaques.

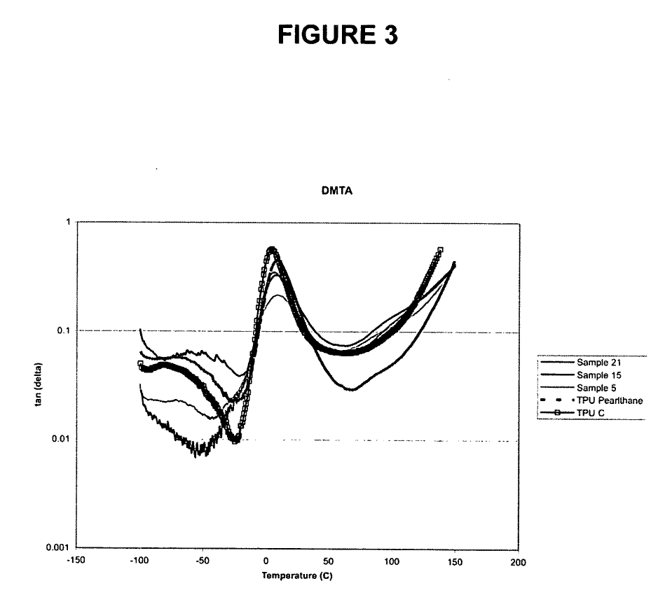

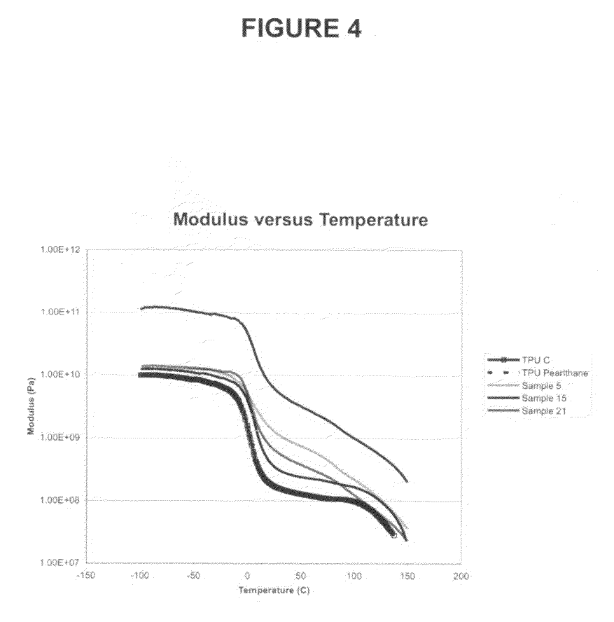

The glass transition temperature of samples 5, 15, 21 and TPU1 and TPU2 were measured by dynamic mechanical thermal analysis (DMTA) as shown in FIG. 3 using a cantilever fixture on a Rheometrics unit. FIG. 3 shows the loss tangent (loss modulus over storage modulus) and FIG. 4 shows the modulus as a function of temperature respectively. Both figures clearly show that all materials exhibit comparable flow behaviour. The Tg appears to be around 0° C. This seems to be higher than that reported for the thermoplastic polyurethanes, however this shift to higher temperatures is known to relate to testing method (i.e. DSC versus DMTA) and testing conditions (e.g strain for DMTA).

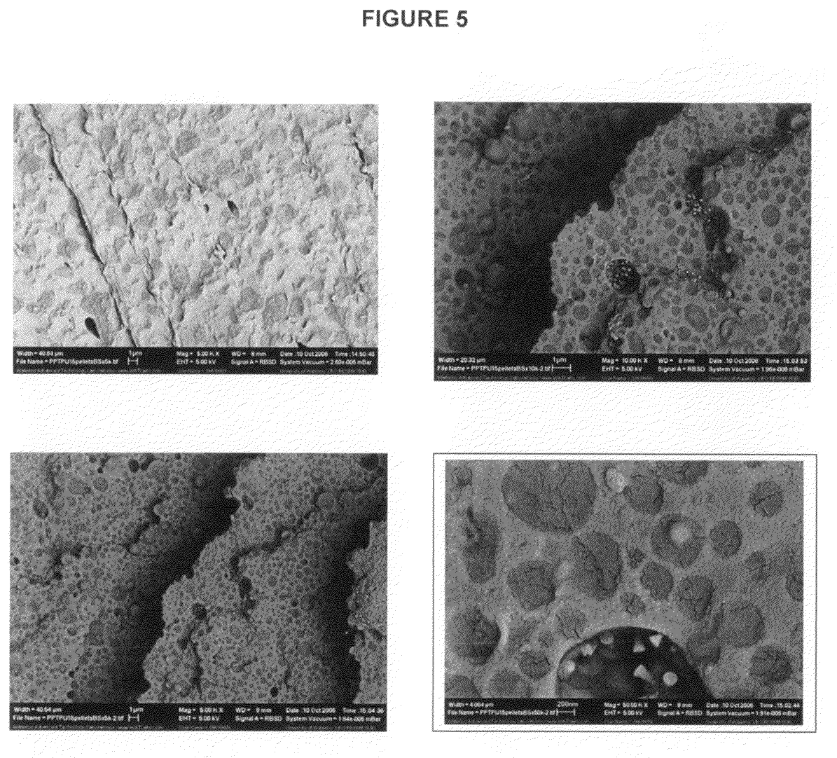

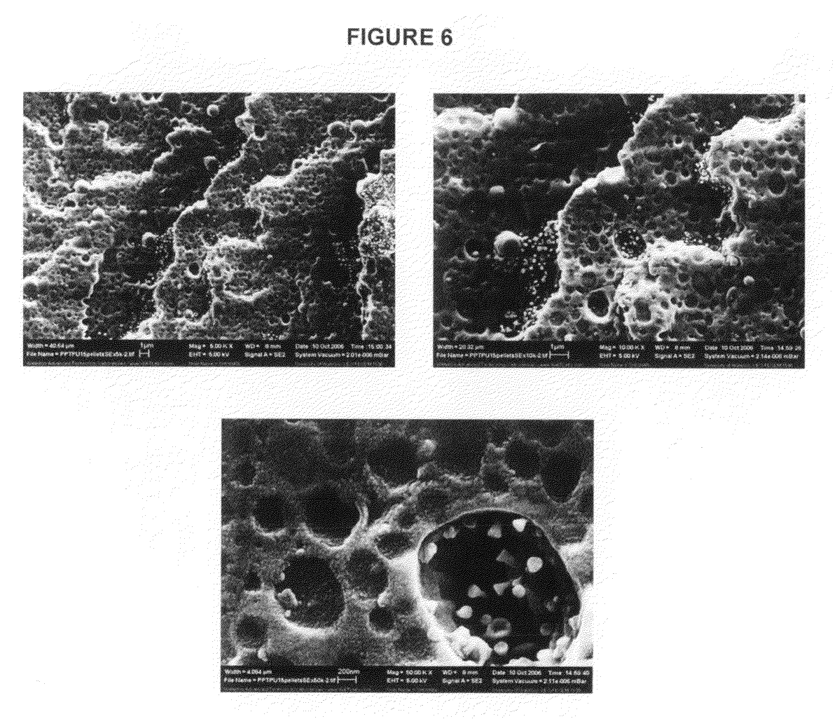

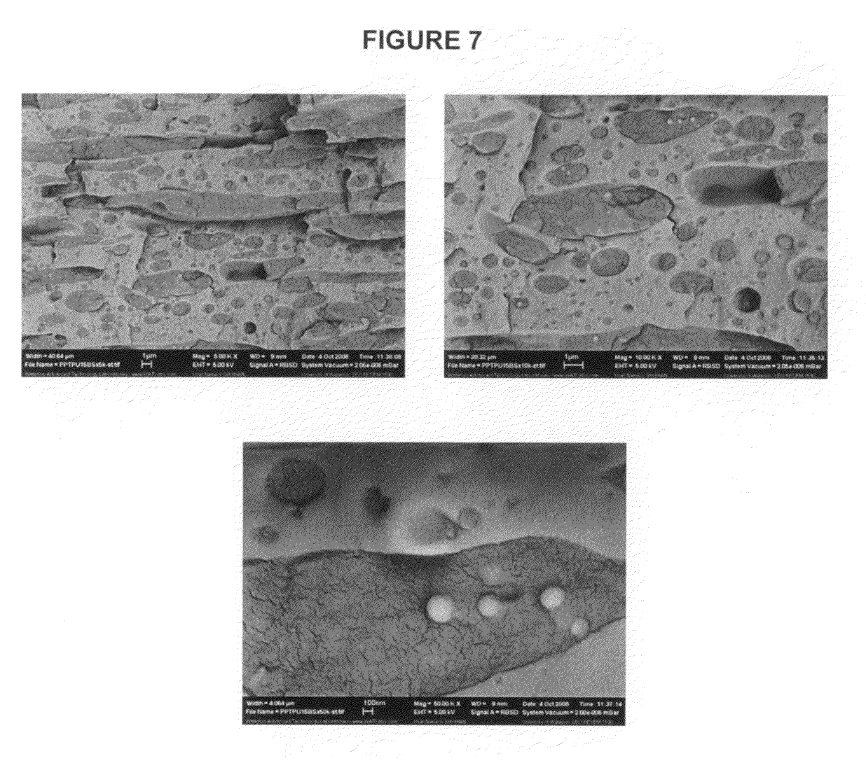

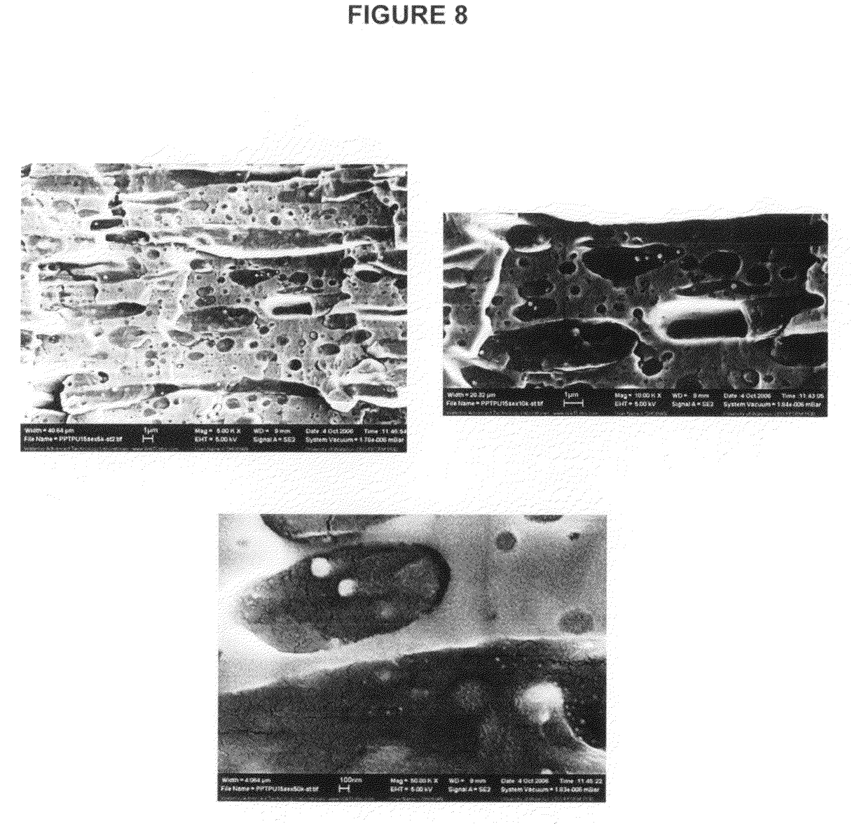

Based on these mechanical results, samples 15 and 21 were selected for morphological characterization by scanning electron microscopy (SEM) due to their high tensile strength and elongation at break. Blends 15 and 21 were made using PP2 and thermoplastic polyurethane TPU1 and TPU2 respectively. In addition, sample 5 was selected randomly from the blends made using PP1. FIGS. 5 and 6 show SEM micrographs of sample 15 as a pellet sample and an injection molded sample, respectively, after staining of the samples with ruthenium oxide for twenty minutes. It can be observed that the images of the injection molded samples exhibit an elongated polypropylene domain dispersed in the thermoplastic polyurethane phase while these domains were rather spherical in the pellet samples. Both primary and secondary (back scattering) images indicate that the blends were very well compatibilized, as shown in FIGS. 7 and 8.

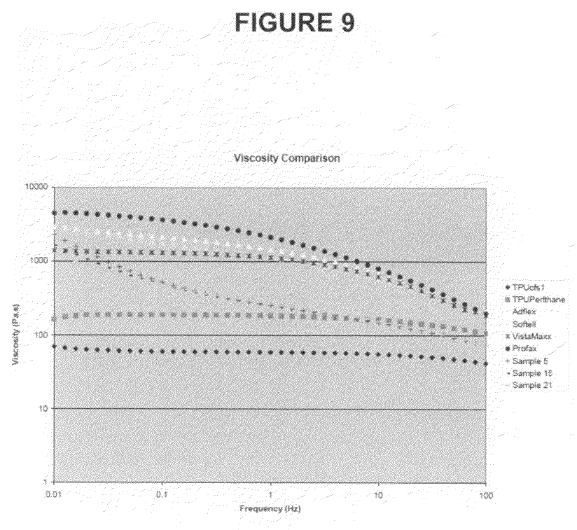

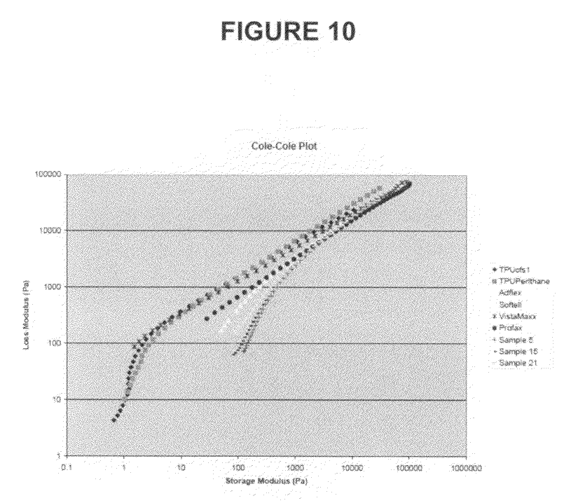

Linear viscoelastic measurements were carried out at 190° C. using a TAI AR200 parallel plate rheometer. Storage and loss moduli data as well as viscosity data are shown in FIGS. 9 and 10. For the purpose of discussion, a comparison is made between samples 5, 15, 21, thermoplastic polyurethanes, polypropylenes, and elastomeric olefins used. FIG. 9 provides a comparison between viscosities of the various samples. It was observed that the elastomeric materials of the present disclosure (samples 5, 15, 21) show viscosities in between those of the thermoplastic polyurethanes (low) and those of the polypropylenes (high). It was also observed that all three samples (5, 15, 21) show an upswing of the viscosity at low frequencies. This behavior is characteristic of a highly elastic material in a low viscosity matrix. The high elasticity comes from the compatibilization reaction between the polypropylene co-polymer and the thermoplastic polyurethanes phases. FIG. 10 compares the relative importance of elastic (storage modulus) versus viscous (loss modulus) behaviour. It is traditionally used to differentiate between materials having varying elastic properties as a result of differences in polydispersity and level of branching. It was observed that for a given value of the loss modulus, the compatibilized samples (5, 15, 21) exhibit higher values of the storage modulus, which results in them having more elastic behaviour.

### Example 3

### Durability Test

A handrail was prepared by replacing 50% of the TPU with a TPU blend of the present disclosure. The handrail was placed on a test rig which uses the drive system from an actual escalator but is run at 210 meters/minute or 7 times the speed of a normal escalator. This test was run continuously for 8 weeks, at the end of which the handrail dimensions were measured and appearance noted. The handrail prepared using a blend of the present disclosure showed acceptable performance in this test.

While the present disclosure has been described with reference to what are presently considered to be the preferred examples, it is to be understood that the disclosure is not limited to the disclosed examples. To the contrary, the disclosure is intended to cover various modifications and equivalent arrangements included within the spirit and scope of the appended claims.

All publications, patents and patent applications are herein incorporated by reference in their entirety to the same extent as if each individual publication, patent or patent application was specifically and individually indicated to be incorporated by reference in its entirety. Where a term in the present application is found to be defined differently in a document incorporated herein by reference, the definition provided herein is to serve as the definition for the term.

TABLE 1

| | | | Flow | Screw | |
|---|---|---|---|---|---|
| Sample | | | Rate | Speed | Diamine:MAH |
| No. | Diamine | MAH-PP | (g/min) | (rpm) | molar ratio |
| Comp. 1 | HMDA | Polybond ® | 50 | 50 | 2:1 |
| | | 3200 | | | |
| Comp. 2 | HMDA | Polybond ® | 75 | 75 | 2:1 |
| | | 3200 | | | |
| Comp. 3 | HMDA | Polybond ® | 75 | 75 | 1.5:1 |
| | | 3150 | | | |

HMDA = hexamethyldiamine

TABLE 2

| | Sample # | | | | | |
|---|---|---|---|---|---|---|
| | 1 | 2 | 3 | 4 | 5 | 6 |
| PP1 | 35 | 35 | 35 | 35 | 35 | 35 |
| PP2 | 0 | 0 | 0 | 0 | 0 | 0 |
| PP3 | 0 | 0 | 0 | 0 | 0 | 0 |
| Comp. 1 | 5 | 10 | 0 | 0 | 0 | 0 |
| Comp. 2 | 0 | 0 | 5 | 10 | 0 | 0 |
| Comp. 3 | 0 | 0 | 0 | 0 | 5 | 10 |
| TPU1 | 60 | 55 | 60 | 55 | 60 | 55 |
| TPU2 | 0 | 0 | 0 | 0. | 0 | 0 |
| Flow Rate | 8.16 | 11.64 | 11.64 | 11.64 | 11.64 | 11.64 |
| (lb/hr) | | | | | | |
| Tensile | 19.0 | 17.1 | 20.9 | 18.4 | 20.8 | 19.8 |
| strength | | | | | | |
| (Mpa) | | | | | | |
| Elongation | 767 | 642 | 658 | 617 | 667 | 600 |
| @ Break | | | | | | |
| (%) | | | | | | |
| | Sample # | | | | | |
| | 7 | 8 | 9 | 10 | 11 | 12 |
| PP1 | 35 | 35 | 35 | 35 | 35 | 35 |
| PP2 | 0 | 0 | 0 | 0 | 0 | 0 |
| PP3 | 0 | 0 | 0 | 0 | 0 | 0 |
| Comp. 1 | 5 | 10 | 0 | 0 | 0 | 0 |
| Comp. 2 | 0 | 0 | 5 | 10 | 0 | 0 |
| Comp. 3 | 0 | 0 | 0 | 0 | 5 | 10 |
| TPU1 | 0 | 0 | 0 | 0 | 0 | 0 |
| TPU2 | 60 | 55 | 60 | 55 | 60 | 55 |
| Flow Rate | | | | | | |
| (lb/hr) | | | | | | |
| Tensile | 16.6 | 15.9 | 17.8 | 16.1 | 18.6 | 16.7 |
| strength | | | | | | |
| (Mpa) | | | | | | |
| Elongation | 667 | 650 | 675 | 658 | 692 | 633 |
| @ Break | | | | | | |
| (%) | | | | | | |
| | Sample # | | | | | |
| | 13 | 14 | 15 | 16 | 17 | 18 |
| PP1 | 0 | 0 | 0 | 0 | 0 | 0 |
| PP2 | 35 | 35 | 35 | 35 | 35 | 35 |
| PP3 | 0 | 0 | 0 | 0 | 0 | 0 |
| Comp. 1 | 5 | 10 | 0 | 0 | 0 | 0 |
| Comp. 2 | 0 | 0 | 5 | 10 | 0 | 0 |
| Comp. 3 | 0 | 0 | 0 | 0 | 5 | 10 |
| TPU1 | 60 | 55 | 60 | 55 | 60 | 55 |
| TPU2 | 0 | 0 | 0 | 0 | 0 | 0 |
| Flow Rate | 12.96 | 12.96 | 12.96 | 12.96 | 13.68 | 12.96 |
| (lb/hr) | | | | | | |
| Tensile | 21.3 | 19.1 | 23.5 | 19.2 | 22.8 | 21.3 |
| strength | | | | | | |
| (Mpa) | | | | | | |
| Elongation | 658 | 625 | 717 | 658 | 692 | 642 |
| @ Break | | | | | | |
| (%) | | | | | | |
| | Sample # | | | | | |
| | 19 | 20 | 21 | 22 | 23 | 24 |
| PP1 | 0 | 0 | 0 | 0 | 0 | 0 |
| PP2 | 35 | 35 | 35 | 35 | 35 | 35 |
| PP3 | 0 | 0 | 0 | 0 | 0 | 0 |
| Comp. 1 | 5 | 10 | 0 | 0 | 0 | 0 |
| Comp. 2 | 0 | 0 | 5 | 10 | 0 | 0 |
| Comp. 3 | 0 | 0 | 0 | 0 | 5 | 10 |
| TPU1 | 0 | 0 | 0 | 0 | 0 | 0 |
| TPU2 | 60 | 55 | 60 | 55 | 60 | 55 |
| Flow Rate | | | | | | |
| (lb/hr) | | | | | | |
| Tensile | 21.0 | 17.4 | 22.2 | 19.7 | 21.1 | 21.0 |
| strength | | | | | | |
| (Mpa) | | | | | | |
| Elongation | 750 | 675 | 750 | 692 | 717 | 708 |
| @ Break | | | | | | |
| (%) | | | | | | |
| | Sample # | | | | | |
| | 25 | 26 | 27 | 28 | 29 | 30 |
| PP1 | 0 | 0 | 0 | 0 | 0 | 0 |
| PP2 | 0 | 0 | 0 | 0 | 0 | 0 |
| PP3 | 35 | 35 | 35 | 35 | 35 | 35 |
| Comp. 1 | 5 | 10 | 0 | 0 | 0 | 0 |
| Comp. 2 | 0 | 0 | 5 | 10 | 0 | 0 |
| Comp. 3 | 0 | 0 | 0 | 0 | 5 | 10 |
| TPU1 | 60 | 55 | 60 | 55 | 60 | 55 |
| TPU2 | 0 | 0 | 0 | 0 | 0 | 0 |
| Flow Rate | 12.96 | 12.6 | 12.6 | 12.6 | 12.6 | 12.6 |
| (lb/hr) | | | | | | |
| Tensile | 10.42 | 14.87 | 18.18 | 17.94 | 14.88 | 14.44 |
| strength | | | | | | |
| (Mpa) | | | | | | |
| Elongation | 508 | 642 | 650 | 600 | 700 | 675 |
| @ Break | | | | | | |
| (%) | | | | | | |
| | Sample # | | | | | |
| | 31 | 32 | 33 | 34 | 35 | 36 |
| PP1 | 0 | 0 | 0 | 0 | 0 | 0 |
| PP2 | 0 | 0 | 0 | 0 | 0 | 0 |
| PP3 | 35 | 35 | 35 | 35 | 35 | 35 |
| Comp. 1 | 5 | 10 | 0 | 0 | 0 | 0 |
| Comp. 2 | 0 | 0 | 5 | 10 | 0 | 0 |
| Comp. 3 | 0 | 0 | 0 | 0 | 5 | 10 |
| TPU1 | 0 | 0 | 0 | 0 | 0 | 0 |
| TPU2 | 60 | 55 | 60 | 55 | 60 | 55 |
| Flow Rate | | | | | | |
| (lb/hr) | | | | | | |
| Tensile | 9.84 | 13.74 | 14.22 | 15.67 | 13.31 | 10.74 |
| strength | | | | | | |
| (Mpa) | | | | | | |
| Elongation | 567 | 667 | 700 | 650 | 683 | 475 |
| @ Break | | | | | | |
| (%) | | | | | | |

PP1: 50% Profax ® 8523 + 50% Adflex ® V109F
PP2: 50% Profax ® 8523 + 50% Vistamaxx ® 3000
PP3: 50% Profax ® 8523 + 50% Softell ® TKS203D
TPU1: Pearlthane ® 12K85A
TPU2: Pearlthane ® D12F75

1. A method of preparing a TPU blend comprising reactively extruding a mixture of a TPU, a polyolefin copolymer blend and an amine-modified polypropylene compatibilizer, wherein the polyolefin copolymer blend is a blend of a polyolefin and an elastomeric olefin.

2. The method of claim 1, wherein the mixture is reactively extruded using a screw extruder.

3. The method of claim 1 or 2, wherein the thermoplastic polyurethane comprises from about 50% to about 60% by weight of the TPU blend.

4. The method of claim 3, wherein the thermoplastic polyurethane comprises about 55% by weight of the TPU blend.

5. The method of any one of claims 1-4, wherein the thermoplastic urethane is a polyester-based thermoplastic polyurethane or a polyether-based thermoplastic polyurethane.

6. The method of claim 5, wherein the thermoplastic urethane is a polyester-based thermoplastic polyurethane.

7. The method of any one of claims 1-6, wherein the polyolefin copolymer blend comprises from about 30% to about 40% by weight of the TPU blend.

8. The method of claim 7, wherein the polyolefin copolymer blend comprises about 35% by weight of the TPU blend.

9. The method of any one of claims 1-8, wherein the polyolefin comprises about 50% by weight of the polyolefin copolymer blend.

10. The method of claim 9, wherein the polyolefin is polyethylene or polypropylene.

11. The method of claim 10, wherein the polyolefin is polypropylene.

12. The method of any one of claims 1-11, wherein the elastomeric olefin comprises about 50% by weight of the polyolefin copolymer blend.

13. The method of claim 12, wherein the elastomeric olefin is an elastomeric polypropylene.

14. The method of claim 13, wherein the elastomeric polypropylene co-crystallizes with the polyolefin.

15. The method of any one of claims 1-14, wherein the amine-modified polypropylene compatibilizer comprises from about 5% to about 10% by weight of the TPU blend.

16. The method of any one of claims 1-15, wherein the amine-modified polypropylene compatibilizer is a blend or reaction product of a maleated polypropylene and a diamine.

17. The method of any one of claims 1-16, wherein the diamine is heated to a molten state and is metered into an extruder during reactive extrusion of the maleated polypropylene

18. The method of any one of claims 1-17, wherein the modified polypropylene compatibilizer is reactively extruded using a twin-screw extruder

19. The method of claim 18, wherein the amine-modified polypropylene compatibilizer is reactively extruded using a molar ratio of diamine:maleated-polypropylene of about 0.5:1 to about 5:1.

20. The method of claim 19, wherein the ratio is about 1:1 to about 3:1.

21. The method of any one of claims 16-20, wherein the diamine is an alkylene diamine.

22. The method of claim 21, wherein the diamine is a C₄₋₁₂alkylene diamine.

23. The method of claim 22, wherein the diamine is hexamethylenediamine or dodecamethyldiamine.

24. The method according to claim 1, comprising combining and reactively extruding a mixture comprising
(a) a thermoplastic polyurethane comprising from about 40% to about 70% by weight of the TPU blend;
(b) a polyolefin copolymer blend comprising from about 20% to about 50% by weight of the TPU blend, wherein the polyolefin copolymer blend comprises
(1) a polyolefin comprising from about 30% to about 70% by weight of the polyolefin copolymer blend, and
(2) an elastomeric olefin comprising from about 30% to about 70% by weight of the polyolefin copolymer blend; and
(c) an amine-modified polypropylene compatibilizer comprising from about 1% to about 15% by weight of the TPU blend.

25. An elastomeric material composition comprising a blend or reaction product of a thermoplastic polyurethane, a polyolefin copolymer blend and an amine-modified polypropylene compatibilizer, wherein the polyolfin colpoymer blend is a blend of a polyolefin and an elastomeric olefin.

26. The elastomeric material composition according to claim 25, comprising a blend or reaction product of:
(a) a thermoplastic polyurethane comprising from about 40% to about 70% by weight of the composition;
(b) a polyolefin copolymer blend comprising from about 20% to about 50% by weight of the composition, wherein the polyolefin copolymer blend comprises
(1) a polyolefin comprising from about 30% to about 70% by weight of the polyolefin copolymer blend, and
(2) an elastomeric olefin comprising from about 30% to about 70% by weight of the polyolefin copolymer blend; and
(c) an amine-modified polypropylene compatibilizer comprising from about 1% to about 15% by weight of the composition.

27. The composition of claim 25 or 26, wherein the thermoplastic polyurethane comprises from about 50% to about 60% by weight of the TPU blend.

28. The composition of claim 27, wherein the thermoplastic polyurethane comprises about 55% by weight of the TPU blend.

29. The composition of any one of claims 25-28, wherein the thermoplastic urethane is a polyester-based thermoplastic polyurethane or a polyether-based thermoplastic polyurethane.

30. The composition of claim 29, wherein the thermoplastic urethane is a polyester-based thermoplastic polyurethane.

31. The composition of any one of claims 25-30, wherein the polyolefin copolymer blend comprises from about 30% to about 40% by weight of the TPU blend.

32. The composition of claim 31, wherein the polyolefin copolymer blend comprises about 35% by weight of the TPU blend.
